(19) United States
(12) Patent Application Publication
(10) Pub. No.: US 2014/0088743 A1
(43) Pub. Date: Mar. 27, 2014

(54) AUDIO WEB-LINK CODES FOR ACCESSING MEDIA CONTENT

(71) Applicants: NEIL BIPINCHANDRA MEHTA, PEPPER PIKE, OH (US); HIMANSHU S. AMIN, SOLON, OH (US)

(72) Inventors: NEIL BIPINCHANDRA MEHTA, PEPPER PIKE, OH (US); HIMANSHU S. AMIN, SOLON, OH (US)

(21) Appl. No.: 13/627,984

(22) Filed: Sep. 26, 2012

(51) Int. Cl. G06F 17/00

(52) U.S. Cl. 700/94

(57) ABSTRACT

Systems and method for monitoring media content consumed by a user through employment of audio web-link codes (AWR codes) associated with respectively consumed media content, and accessing the consumed media content as well as supplemental information regarding the media content via the AWR codes.

This application relates to employment of audio web-link codes to facilitate access to media content.

### BACKGROUND

Content consumers often view or listen to vast amounts of content through television, the Internet, streaming content, radio, and other content sources. Oftentimes, content consumers desire to re-consume content accessed in the past or learn more about such consumed content, and without having taken affirmative steps to mark or save such content re-consuming or learning more about the already accessed content can be difficult given the vast amount of content the consumer may have accessed.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the purpose of this summary is to present some concepts related to some exemplary non-limiting embodiments in simplified form as a prelude to more detailed description of the various embodiments that follow in the disclosure.

In accordance with one or more embodiments and corresponding disclosure, various non-limiting aspects are described in connection with dynamically logging media content consumed by a user through monitoring and logging audio web-link codes (AWR codes) associated with consumed media content. The AWR codes can provide links to the consumed media content as well as links to supplemental information related to the consumed media content.

In accordance with a non-limiting embodiment, in an aspect, a system is provided comprising a memory having stored thereon computer executable components, and a processor configured to execute the following computer executable components stored in the memory:

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a high-level block diagram of an exemplary non-limiting AWR detection and accessing system.

FIG. 2 illustrates a block diagram of another exemplary non-limiting AWR detection and accessing system.

FIG. 3 illustrates a block diagram of another exemplary non-limiting AWR detection, accessing, and generation system.

FIG. 4 illustrates an exemplary non-limiting flow diagram of AWR detection, logging, and matching.

FIG. 5 is a block diagram representing an exemplary non-limiting networked environment in which the various embodiments can be implemented.

FIG. 6 is a block diagram representing an exemplary non-limiting computing system or operating environment in which the various embodiments may be implemented.

### DETAILED DESCRIPTION

### Overview

Various aspects or features of this disclosure are described with reference to the drawings, wherein like reference numerals are used to refer to like elements throughout. In this specification, numerous specific details are set forth in order to provide a thorough understanding of the subject disclosure. It should be understood, however, that the certain aspects of disclosure may be practiced without these specific details, or with other methods, components, materials, etc. In other instances, well-known structures and devices are shown in block diagram form to facilitate describing the subject disclosure.

By way of introduction, the subject matter disclosed herein relates to monitoring media content consumed by a user through employment of audio web-link codes (AWR codes) associated with respectively consumed media content, and accessing the consumed media content as well as supplemental information regarding the media content via the AWR codes. More particularly, in accordance with a non-limiting implementation, as a user is consuming content, a device (e.g., cell phone, personal data assistant, tablet computer, laptop computer, television, radio, vehicle, . . . ) is listening to the media content being consumed and detects AWR codes associated with the media content. The device logs and/or saves the AWR codes, time stamps the logged/saved AWR codes, and provides an interface that the user can access at a later point in time to review content consumed, re-access the content, and/or access supplemental information associated with the consumed content. The AWR codes can for example be associated with the media content, transmitted just prior to the media content, or after the media content, or during transmission of the media content. In a non-limiting embodiment, the AWR codes can be transmitted at a radio frequency not discernable by humans but still detectable by the device. In another embodiment, the AWR code can be a set of tones that can be heard by a human. In yet another embodiment, the AWR code can be a subset of audio that is part of the media content being transmitted. The AWR code can function in a manner similar to QR codes or bar codes, and thus encode information that provides for a user to access web-based content via the code. Accordingly, the device can monitor media being consumed by the user, and track such consumed media content via respective AWR codes as well as provide the user with access to the media content or information related therewith by employment of the respective AWR codes.

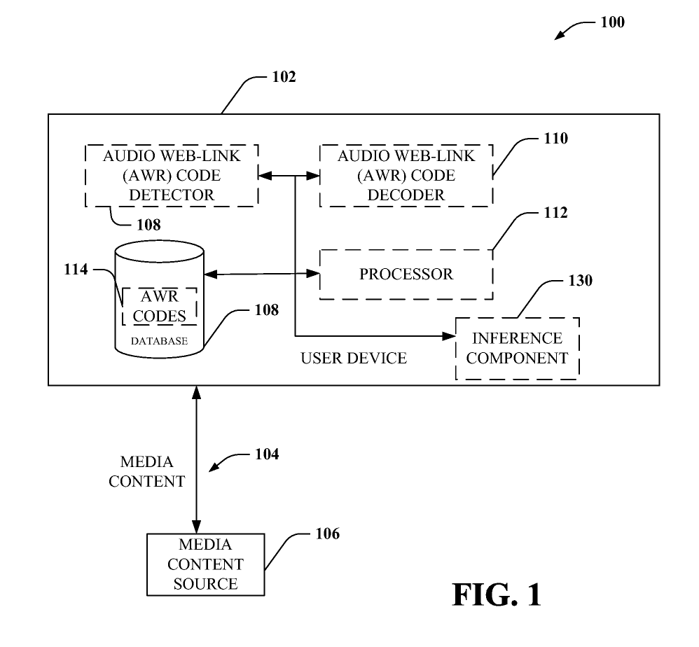

Referring now to the drawings, with reference initially to FIG. 1, a media content monitoring system 100 is shown that facilitates monitoring consumed media content. Aspects of the systems, apparatuses or processes explained herein can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory (not depicted) for storing computer executable components and instructions. A processor 112 can facilitate operation of the computer executable components and instructions by the system 100.

A user device 102 receives media content 104 from a media content source 106 (e.g., website, channel, server, radio station, television station, retail stores, malls, mobile devices, personal computers, tablet computers, etc.). Along with transmission of the media content 104, AWR code(s) associated with respective media content are received by the user device 102. An AWR detector 108 detects AWR codes associated with the media content 104 being consumed. An AWR decoder 110 decodes the AWR codes, and provides a means for accessing encoded media content associated with the decoded AWR code. For example, the decoded AWR code can provide a hyperlink to the media content, text associated with the media content, an SMS message, an MMS message, near field communications (NFC), blue tooth, an image, open a channel or communication link between the user device and the media source, e.g., for streaming of the media content. The user device 102 can log or save the detected AWR codes so that the user can at a later point in time review media content consumed, access subsets of the consumed media content as well as access subsets of information related to the consumed media content. The AWR codes can encode information such as text, uniform resource locators (URLs), images, logos, channels, IP addresses, communication links, and other types of information that will enable the user to access information related to media content associated with the AWR code(s). The user device can store the detected AWR codes locally and/or remotely. Moreover, the logging and/or storage of the AWR codes can be managed to accommodate memory/storage constraints. For example, older or unused AWR codes can be aged out or archived in long-term memory. Frequently accessed AWR codes can be ranked higher and saved in cache for easy access.

The user device can be any suitable computing device associated with a user and configured to interact with and/or receive media content. For example, the user device can include a desktop computer, a laptop computer, a smart-phone, a cellular phone, a tablet personal computer (PC), a dedicated device, or a PDA. As used herein, the term user refers to a person, entity, or system that uses a client device to employ content delivery system 100 (or additional systems described herein). In an aspect, the user device and/or content delivery system 100 (or additional systems described herein) is configured to access media content via for example a network such as the Internet, an intranet, cellular service, radio broadcast, television broadcast, media encoded on a computer readable medium, near field communication, ultra wide band communication, Wi-Fi, broadband communications, or the like.

Media content 104 can include media data associated with one or more data sources (not shown) that can be accessed by a client device (not shown) and/or by a content delivery system such as system 100 (and additional system described herein). For example, a data source can include a data store storing media content and affiliated with a content provider that employs content distribution service 100. In another aspect, a data source can include a data store storing media content that is remote from a content provider and/or a content distribution system 100. In an aspect, media files can include media data as media items. For example, a media file can include one or more media items. A media item can include video and/or audio media data, including but not limited to movies, television, streaming television, video games, or music tracks.

In order to provide for or aid in the numerous inferences described herein (e.g., inferring characteristics of media items and audio tracks, inferring suitable audio track for dubbing to media items, inferring descriptions of media items and audio tracks, and etc), an inference component 130 can examine the entirety or a subset of the data to which it is granted access and can provide for reasoning about or infer states of the system, environment, etc. from a set of observations as captured via events and/or data. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events and/or data.

The inference component 130 can facilitate automated action in connection with features described in this disclosure. For example, which AWR codes are relevant to a particular user, utility of one or more AWR codes to a user, state or context associated with a user, preferences of a user given historical preferences and/or current context of the user.

Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

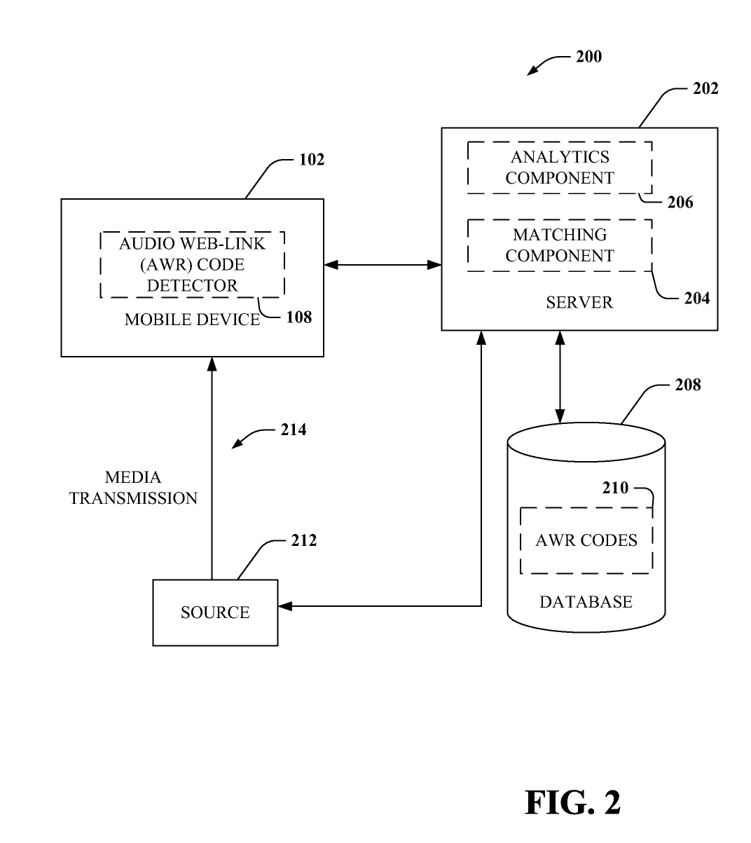

FIG. 2 illustrates an embodiment of a system 200 that uses a remote server 202 to facilitate matching decoded AWR codes with sources of media content. The user device 102 receives a media transmission 214 from a media source 212, and the AWR detector 108 identifies AWR codes associated with the media transmission. The user device communicates with the server 202, and the server uses a matching component 204 identifies detected AWR codes using a database 210 of AWR codes. The server 202 can provide to the user device 202 access to one or more sources associated with the identified AWR code. It is to be appreciated that sources of media content can design respective AWR codes to enable access to particular media items.

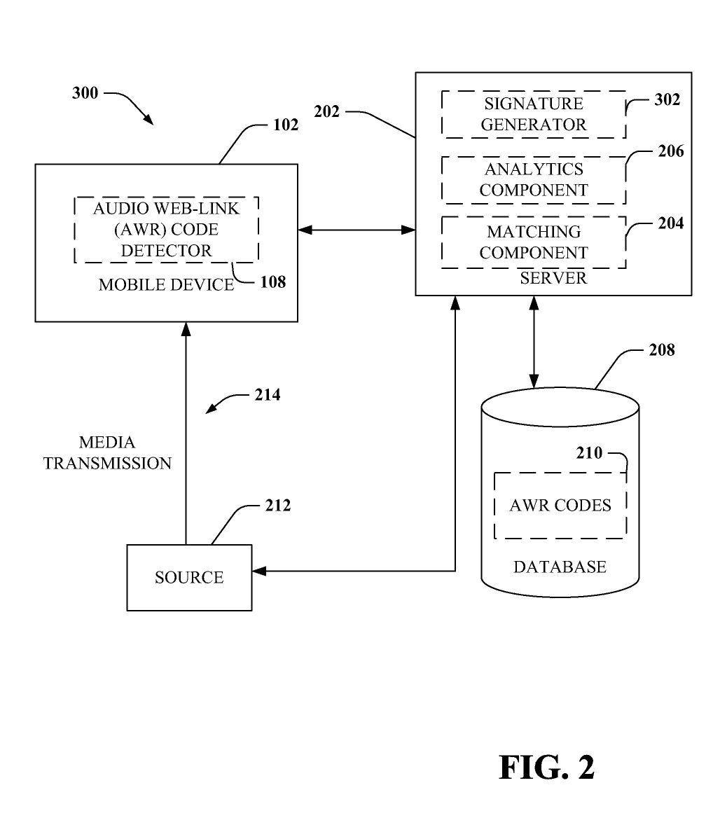

FIG. 3 illustrates an embodiment of system 200 that includes a signature generator 302 that enables a source of media content to create a customized AWR code. In an aspect, the signature generator can associate tones present in a media transmission to encode information. For example, a subset of a sound bite can be used as an AWR code to identify an entire media file that includes the sound bite. In another aspect, hidden tones (e.g., outside range of human hearing) can be encoded in an AWR code that can be detected by an AWR detector. Accordingly, the AWR codes that are transmitted with a media file can be transparent to a user from a visual or audio standpoint (e.g., an audio watermark).

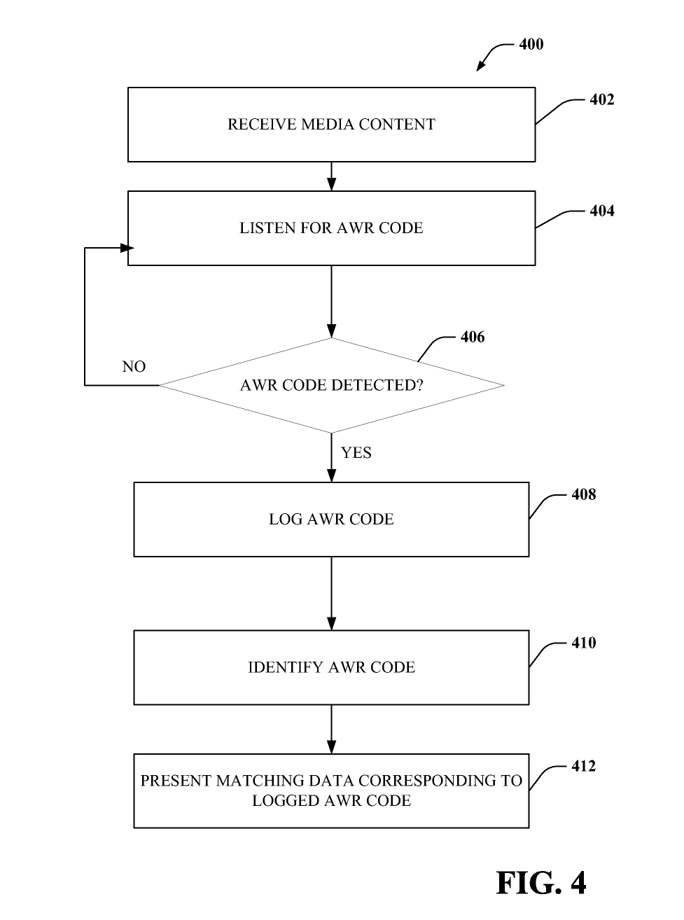

FIG. 4 illustrates a methodology 400 in accordance with certain aspects of this disclosure. While, for purposes of simplicity of explanation, the methodologies are shown and described as a series of acts, it is to be understood and appreciated that this disclosure is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with certain aspects of this disclosure. Additionally, it is to be further appreciated that the methodologies disclosed hereinafter and throughout this disclosure are capable of being stored on an article of manufacture to facilitate transporting and transferring such methodologies to computers.

At 402 media content is received. At 404, listening for AWR codes is initiated. At 406, a determination is made regarding whether or not an AWR code has been detected. If no, the process returns to 404. If yes, at 408 the detected AWR code is logged. At 410, the AWR code is identified. At 412, matching data corresponding to the AWR code is presented.

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention is not to be limited to any single embodiment, but rather can be construed in breadth, spirit and scope in accordance with the appended claims.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

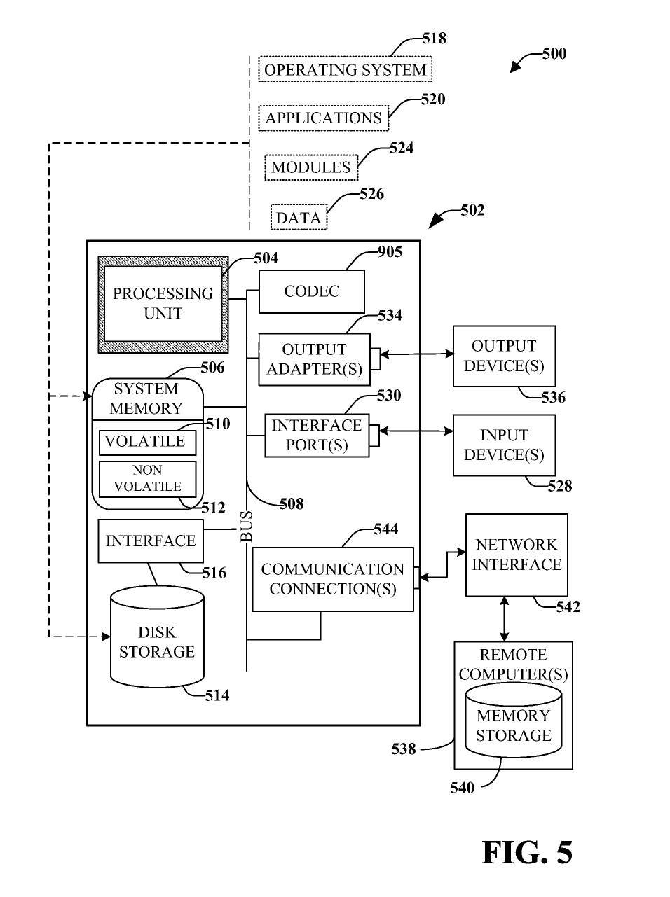

With reference to FIG. 5, a suitable environment 500 for implementing various aspects of the claimed subject matter includes a computer 502. The computer 502 includes a processing unit 504, a system memory 506, a codec 505, and a system bus 508. The system bus 508 couples system components including, but not limited to, the system memory 506 to the processing unit 504. The processing unit 504 can be any of various available processors. Dual microprocessors and other multiprocessor architectures also can be employed as the processing unit 504.

The system bus 508 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 506 includes volatile memory 510 and non-volatile memory 512. The basic input/output system (BIOS), containing the basic routines to transfer information between elements within the computer 502, such as during start-up, is stored in non-volatile memory 512. In addition, according to present innovations, codec 505 may include at least one of an encoder or decoder, wherein the at least one of an encoder or decoder may consist of hardware, a combination of hardware and software, or software. Although, codec 505 is depicted as a separate component, codec 505 may be contained within non-volatile memory 512. By way of illustration, and not limitation, non-volatile memory 512 can include read only memory (ROM), programmable ROM (PROM), electrically programmable ROM (EPROM), electrically erasable programmable ROM (EEPROM), or flash memory. Volatile memory 510 includes random access memory (RAM), which acts as external cache memory. According to present aspects, the volatile memory may store the write operation retry logic (not shown in FIG. 5) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 502 may also include removable/non-removable, volatile/non-volatile computer storage medium. FIG. 5 illustrates, for example, disk storage 514. Disk storage 514 includes, but is not limited to, devices like a magnetic disk drive, solid state disk (SSD) floppy disk drive, tape drive, Jaz drive, Zip drive, LS-70 drive, flash memory card, or memory stick. In addition, disk storage 514 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 514 to the system bus 508, a removable or non-removable interface is typically used, such as interface 516.

It is to be appreciated that FIG. 5 describes software that acts as an intermediary between users and the basic computer resources described in the suitable operating environment 500. Such software includes an operating system 518. Operating system 518, which can be stored on disk storage 514, acts to control and allocate resources of the computer system 502. Applications 520 take advantage of the management of resources by operating system 518 through program modules 524, and program data 526, such as the boot/shutdown transaction table and the like, stored either in system memory 506 or on disk storage 514. It is to be appreciated that the claimed subject matter can be implemented with various operating systems or combinations of operating systems.

A user enters commands or information into the computer 502 through input device(s) 528. Input devices 528 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 504 through the system bus 508 via interface port(s) 530. Interface port(s) 530 include, for example, a serial port, a parallel port, a game port, and a universal serial bus (USB). Output device(s) 536 use some of the same type of ports as input device(s) 528. Thus, for example, a USB port may be used to provide input to computer 502, and to output information from computer 502 to an output device 536. Output adapter 534 is provided to illustrate that there are some output devices 536 like monitors, speakers, and printers, among other output devices 536, which require special adapters. The output adapters 534 include, by way of illustration and not limitation, video and sound cards that provide a means of connection between the output device 536 and the system bus 508. It should be noted that other devices and/or systems of devices provide both input and output capabilities such as remote computer(s) 538.

Computer 502 can operate in a networked environment using logical connections to one or more remote computers, such as remote computer(s) 538. The remote computer(s) 538 can be a personal computer, a server, a router, a network PC, a workstation, a microprocessor based appliance, a peer device, a smart phone, a tablet, or other network node, and typically includes many of the elements described relative to computer 502. For purposes of brevity, only a memory storage device 540 is illustrated with remote computer(s) 538. Remote computer(s) 538 is logically connected to computer 502 through a network interface 542 and then connected via communication connection(s) 544. Network interface 542 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 544 refers to the hardware/software employed to connect the network interface 542 to the bus 508. While communication connection 544 is shown for illustrative clarity inside computer 502, it can also be external to computer 502. The hardware/software necessary for connection to the network interface 542 includes, for exemplary purposes only, internal and external technologies such as, modems including regular telephone grade modems, cable modems and DSL modems, ISDN adapters, and wired and wireless Ethernet cards, hubs, and routers.

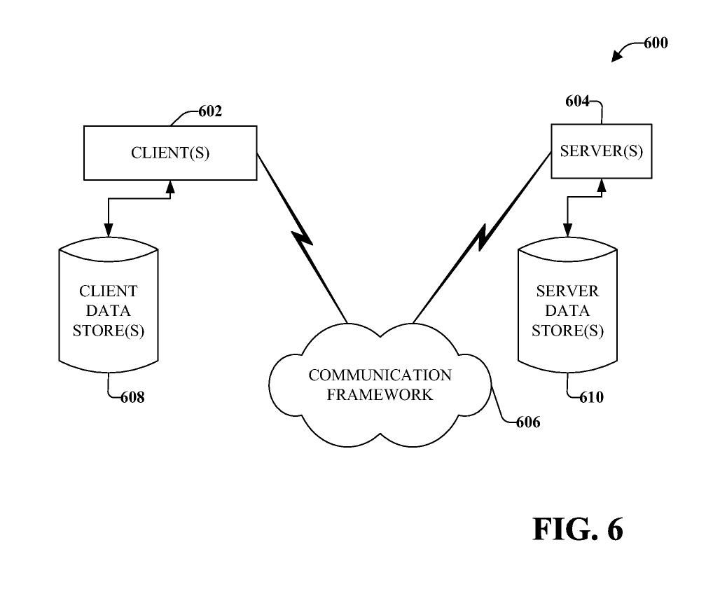

Referring now to FIG. 6, there is illustrated a schematic block diagram of a computing environment 600 in accordance with this specification. The system 600 includes one or more client(s) 602 (e.g., laptops, smart phones, PDAs, media players, computers, portable electronic devices, tablets, and the like). The client(s) 602 can be hardware and/or software (e.g., threads, processes, computing devices). The system 600 also includes one or more server(s) 604. The server(s) 604 can also be hardware or hardware in combination with software (e.g., threads, processes, computing devices). The servers 604 can house threads to perform transformations by employing aspects of this disclosure, for example. One possible communication between a client 602 and a server 604 can be in the form of a data packet transmitted between two or more computer processes wherein the data packet may include video data. The data packet can include a metadata, e.g., associated contextual information, for example. The system 600 includes a communication framework 606 (e.g., a global communication network such as the Internet, or mobile network(s)) that can be employed to facilitate communications between the client(s) 602 and the server(s) 604.

Communications can be facilitated via a wired (including optical fiber) and/or wireless technology. The client(s) 602 include or are operatively connected to one or more client data store(s) 608 that can be employed to store information local to the client(s) 602 (e.g., associated contextual information). Similarly, the server(s) 604 are operatively include or are operatively connected to one or more server data store(s) 610 that can be employed to store information local to the servers 604.

In one embodiment, a client 602 can transfer an encoded file, in accordance with the disclosed subject matter, to server 604. Server 604 can store the file, decode the file, or transmit the file to another client 602. It is to be appreciated, that a client 602 can also transfer uncompressed file to a server 604 and server 604 can compress the file in accordance with the disclosed subject matter. Likewise, server 604 can encode video information and transmit the information via communication framework 606 to one or more clients 602.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

What is claimed is:

1. A device, comprising:
a memory having stored thereon computer executable components; and
a processor configured to execute the following computer executable components stored in the memory:
an audio web-link (AWR) code detector that detects at least one AWR code associated with received media content, wherein the at least one AWR code is audio data that encodes information regarding the received media content.

2. The device of claim 1, wherein the AWR code detector logs or saves the at least one AWR code.

3. The device of claim 1, comprising an AWR code decoder that decodes the AWR code.

4. The device of claim 3, wherein the AWR code decoder decodes the AWR code to reveal a uniform resource locator (URL) associated with the received media file.

5. The device of claim 3, wherein the AWR code decoder decodes the AWR code to reveal at least one of text, URLs, images, logos, artists, metadata, manufacturer, service provider, supplier, related content, related information, background information, or source of the media content.

10. A method, comprising:
using a processor to execute computer executable instructions stored in a memory to perform the following acts:
receiving media content;
detecting at least one audio web-link (AWR) code associated with the received media content, wherein the AWR code encodes in an audio format information regarding the received media content; and
decoding the at least one AWR code, and retrieving from the recoded AWR code information regarding the received media content.

11. The method of claim 10 comprising retrieving a uniform resource locator (URL) from the decoded AWR code.

12. The method of claim 10 comprising retrieving the AWR code within a frequency range of ______ to ______.

13. The method of claim 10, comprising retrieving image information with the AWR code.

14. The method of claim 10, comprising logging or storing the decoded AWR code and retrieved information regarding the media content.

15. The method of claim 14, comprising using the decoded AWR code information to provide a user with access to the media content or information associated with the media content.

16. The method of claim 10, comprising receiving instructions from a user during consumption of the media content to save information regarding the media content, and saving the AWR code or the information decoded from the AWR code.

18. A system, comprising:
means for receiving media content;
means for detecting at least one audio web-link (AWR) code associated with the received media content, wherein the AWR code encodes in an audio format information regarding the received media content; and
means for decoding the at least one AWR code, and retrieving from the recoded AWR code information regarding the received media content.
